(19) United States
(12) Patent Application Publication
(10) Pub. No.: US 2015/0370745 A1
(43) Pub. Date: Dec. 24, 2015

(54) SYSTEM AND METHOD FOR COMMUNICATION PORT BASED ASSET MANAGEMENT

(71) Applicant: Key Systems, Inc., Fishers, NY (US)

(72) Inventors: George H. Eckerdt, Victor, NY (US); Thomas Rockwell, Rochester, NY (US); Christopher B. Miller, Webster, NY (US)

(21) Appl. No.: 14/310,081

(22) Filed: Jun. 20, 2014

(51) Int. Cl. G06F 13/42; H04W 8/14

(52) U.S. Cl. CPC G06F 13/4221; H04W 8/14

(57) ABSTRACT

An identifier of an asset is retrieved using a first communication protocol and is converted to a form compatible with a second communication protocol. Translation circuitry can convert the identifier and can transmit the converted identifier to a communication bus that uses the second communication protocol. An identifier from a USB device can be converted to a Dallas Semiconductor/Maxim Integrated 1-Wire protocol format in an example, and an RFID identifier can be converted to 1-Wire protocol format in another example.

### FIELD

The claimed invention generally relates to methods and systems for secure asset management.

### BACKGROUND

There is a need to store and track valuable assets, such as, but not limited to devices such as smartphones, tablets, cameras, thumb drives, and laptops. It is desirable to have a system and method to track and manage access to those assets, such that certain assets may be accountably assigned to a user without a requirement to add a cumbersome tracking device to the asset. Furthermore, there is a need for the system to be able to recognize when a particular asset has been returned.

### BRIEF DESCRIPTION OF THE DRAWINGS

FIG. 1 schematically illustrates one embodiment of a system for asset management.

FIG. 2 schematically illustrates another embodiment of a system for asset management, including multiple security asset managers.

FIG. 3 schematically illustrates one embodiment of an asset tracking device.

FIG. 4 schematically illustrates one embodiment of a security asset manager having a communication bus.

FIG. 5 schematically illustrates one embodiment of a system for asset management having a communication bus.

FIGS. 6-9 schematically illustrate different embodiments of a security asset manager.

FIGS. 10A-10B schematically illustrate connection embodiments for a security asset manager.

FIGS. 11-12C schematically illustrate embodiments of a system for asset management having universal serial bus (USB) and radio frequency identification (RFID) tracking communication ports.

FIG. 13 schematically illustrates one embodiment of a system for asset management having a USB tracking communication port.

FIG. 14 schematically illustrates one embodiment of a system for asset management having an RFID tracking communication port.

FIG. 15 schematically illustrates one embodiment of system for asset management having a near field communication (NFC) tracking communication port.

FIGS. 16A-16D schematically illustrate one embodiment of an asset management device having a tracking communication port positioned to couple with an asset communication port such that the asset prevents access to a storage area.

FIGS. 17A-17B schematically illustrate another embodiment of an asset management device including a latch to help prevent unauthorized removal of the asset, and having a tracking communication port positioned to couple with an asset communication port such that the asset prevents access to a storage area.

FIGS. 18-21 illustrate different embodiments of a method for asset management.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

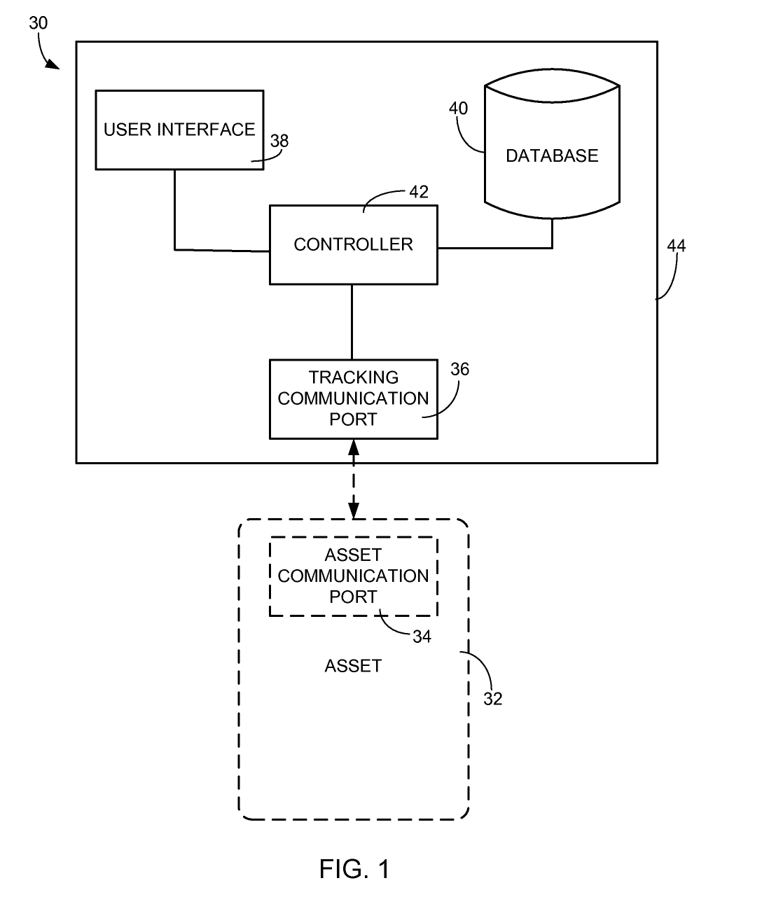

FIG. 1 schematically illustrates a system for asset management 30. The system 30 can be used with one or more assets. For simplicity, an example asset 32 is illustrated in this embodiment. The asset 32 has an asset communication port 34, such as, but not limited to a universal serial bus (USB) port, a firewire port, a Bluetooth port, a near field communication (NFC) port, a radio frequency (RF) port, a serial communication port, a parallel communication port, or an optical communication port. Such communication ports are well known to those skilled in the art. Although not required, it is preferred that the asset communication port 34 is integral with the asset 32 so that a user is not required to attach additional hardware/devices to the asset in order to track the asset. Examples of assets may include, but are not limited to smartphones, digital music players, cameras, camcorders, tablets, computers, laptops, and thumb drives. If an asset communication port needs to be added to an asset, then one non-limiting example of a suitable asset communication port includes a radio frequency identification (RFID) tag.

The system 30 has a tracking communication port 36 configured to be removably coupled to an asset communication port 34. Examples of a suitable tracking communication port 36 include, but are not limited to a universal serial bus (USB) port, a firewire port, a Bluetooth port, a near field communication (NFC) port, a radio frequency (RF) port, a serial communication port, a parallel communication port, or an optical communication port. The type of tracking communication port 36 would determine the type of asset communication port 34 it could be coupled with. Although only one tracking communication port 36 is shown in this example, it should be understood that other embodiments could include multiple tracking communication ports, including embodiments where there are different types of tracking communication ports. In further embodiments, the tracking communication port 36 could be a hub such as, but not limited to, a USB hub, whereby multiple assets (each having their own asset communication port) can couple to the tracking communication port (a hub in this case). For simplicity of explanation, a single tracking communication port is shown in many embodiments, but it should be understood that multiple ports and/or hubs may be used in other embodiments.

The system 30 also has a user interface 38 and a database 40. Suitable examples of a user interface include, but are not limited to a keypad, a touchscreen, a fingerprint reader, a proximity card reader, an iris identification device, a retinal scanning identification device, a hand shape identification device, and a magnetic card reader. At the very least, the user interface 38 may be used to allow a user to present credentials (as non-limiting examples, a pin number, a code, a biometric, or a passcard or keytag) to the system 30 for the purposes of access authorization and/or user identification. The database 40 is configurable to store one or more asset records. Asset records may include, but are not limited to, records showing when a user has taken or returned an asset. The database 40 may include, but is not limited to a storage device, a memory, a hard drive, a random access memory (RAM), a non-volatile RAM (NVRAM), an optical disc, magnetic storage media, flash memory, phase change memory, holographic data storage, molecular memory, and any plurality and/or combination thereof.

The system 30 also has a controller 42 coupled to the at least one tracking communication port 36, the database 40, and the user interface 38. The controller 42 is configured to identify a user via the user interface 38; sense when an asset 32, having the asset communication port 34, couples to the at least one tracking communication port 36 via its asset communication port 34; query the asset 32 for at least one unique asset identifier; and store a record corresponding to the at least one unique asset identifier. The controller 42 may include, but is not limited to, a computer, a microprocessor, an application specific integrated circuit (ASIC), a field programmable gate array (FPGA), digital circuitry, analog circuitry, or any combination and/or plurality thereof, whether local or distributed. The at least one unique asset identifier may include, but is not limited to a media access control (MAC) address, a vendor identification (VID), a product identification (PID), a product serial string, or any combination thereof. The product serial string could also be referred to as a serial number, and may include any combination of letters, numbers, bit values, and/or byte values which uniquely identify the asset to the system 30.

As just one example, if the asset 32 has a USB asset communication port 34, and the system's tracking communication port 36 also is a USB port, then the two ports 34, 36 could be removably coupled. The controller 42 can be configured to sense when the asset's USB port is plugged in and can act as a USB host device. The controller 42 may be configured to ask the USB asset what USB profiles it has available, and the asset will list the most complex to the least complex profiles (or device types), per the USB Protocol which is known to those skilled in the art. Since all USB devices can respond as a simple memory device, such as a thumb drive, regardless of what type of device they actually are, a basic USB driver, familiar to those skilled in the art, can be configured and used on the controller 42 and will result in the USB asset providing a VID, PID, and serial number when it is plugged in to the tracking communication port. The serial number may be all that is needed by the controller 42 as a unique asset identifier, or some combination of VID, PID, and serial number may be used. Those skilled in the art will see that similar drivers to obtain unique asset identifiers may be similarly implemented for other communication protocols and port/device types.

Depending on the embodiment, the system 30 for asset management may be self-contained in a security asset manager (SAM) 44, or one or more elements may be distributed in different locations.

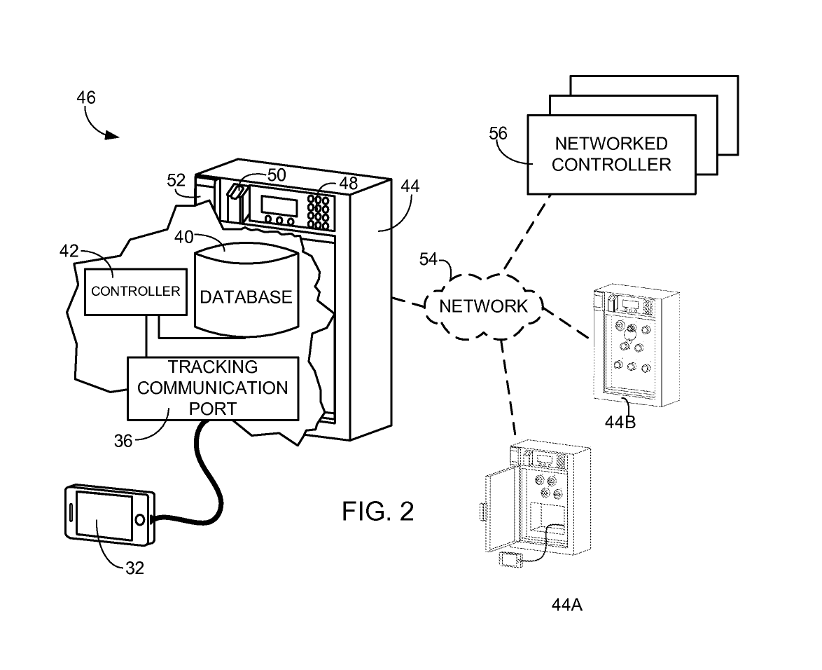

FIG. 2 schematically illustrates another embodiment of a system for asset management 46. The system 46 includes a security asset manager (SAM) 44, the features of which have been discussed above. Depending on the embodiment, the user interface of the SAM 44 may include one or more of a variety of user identification (ID) devices, such as, but not limited to, a keypad 48 for personal identification number (PIN) entry, a fingerprint reader 50, and a proximity card reader 52. Other non-limiting options for user identification have been discussed in the previous example. Depending on the embodiment, the SAM 44 may have a door (not shown in the partially exploded view) with an electronically controllable lock which may be unlocked by the SAM 44 following the user identification. Other embodiments may have one or more other doors which can act as electronically controllable lockers and/or provide controlled access to one or more assets separately from other assets. Some embodiments may not have a door at all.

The SAM 44 may be coupled to and/or in communication with one or more other SAMs 44A, 44B via a network 54. One or more networked controllers 56 may also be coupled to one or more SAMs via the network 54. The network 54 may be, but is not limited to, a local area network (LAN), a wide area network (WAN), a wireless LAN, a wireless WAN, or any combination or plurality thereof. In some embodiments, one of the one or more networked controllers 56 may be a server running asset management software for coordinating and collecting data from one or more SAMs, as well as providing reports on authorized user activity, asset status, and alarms. One suitable example of asset management software is the Global Facilities Management System (GFMS) software available from Key Systems, Inc. In other embodiments, another of the one or more networked controllers 56 may include, but is not limited to, a computer, a laptop, a smartphone, and/or a cellular phone which is able to interact via a browser or other web enabled client with either a remote server running asset management software or an embedded web server in one of the SAMs.

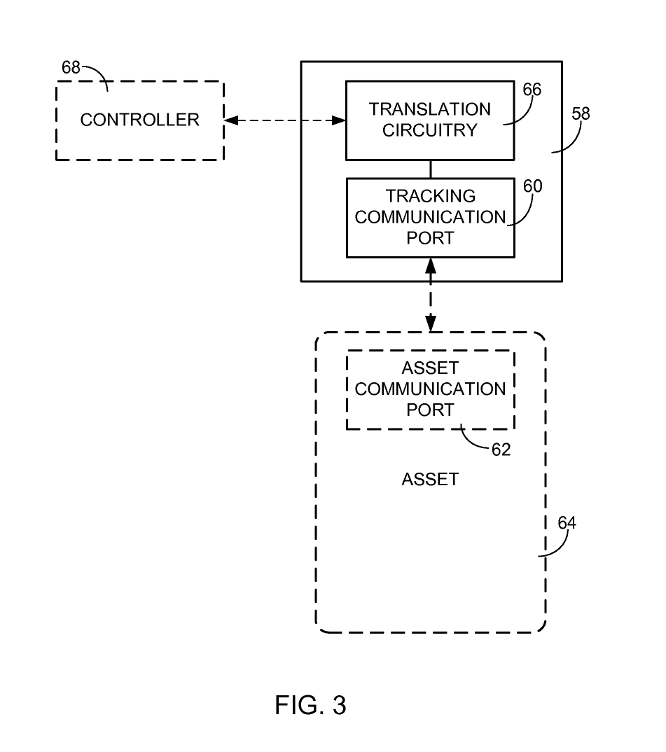

FIG. 3 schematically illustrates an asset tracking device 58. The asset tracking device 58 has at least one tracking communication port 60 configured to be removably coupled to an asset communication port 62. The asset communication port 62 is part of or coupled to an asset 64. The asset 64 is separate from the asset tracking device 58, and suitable non-limiting examples of an asset include but are not limited to smartphones, digital music players, cameras, camcorders, tablets, computers, laptops, and thumb drives. Suitable non-limiting examples of the asset tracking communication port 60 include a universal serial bus (USB) port, a firewire port, or a radio frequency (RF) port such as a radio frequency identification (RFID) port, a near field communication (NFC) port, or a Bluetooth port. Suitable non-limiting examples of an asset communication port include an RFID tag, a universal serial bus (USB) port, a firewire port, or a radio frequency (RF) port, a near field communication (NFC) port, or a Bluetooth port.

The asset tracking device 58 also has translation circuitry 66 coupled to the at least one tracking communication port 60. The translation circuitry 66 is configured to sense when an asset 64, having an asset communication port 62, couples to the at least one tracking communication port 60 via its asset communication port 62. The translation circuitry 66 is further configured to query the asset 64 for at least one unique asset identifier, over the coupled communication ports 60, 62. As in previous embodiments, the coupling between the communication ports does not need to be a wired connection, and may instead be a non-wired connection, such as, but not limited to an optical or radio frequency connection.

The translation circuitry 66 is further configured to present the at least one unique asset identifier to a controller 68. As has been discussed above, the asset is first queried over the tracking communication port 60 to obtain the at least one unique asset identifier. This query occurs with a first communication protocol, compatible with the asset communication port 62 of the asset 64. Examples of such first communication protocols include, but are not limited to a radio frequency identification (RFID) protocol, a radio frequency (RF) protocol, a near field communication (NFC) protocol, a Bluetooth protocol, a universal serial bus (USB) protocol, a firewire protocol, a serial communication protocol, a parallel communication protocol, and an optical communication protocol.

When the translation circuitry 66 presents the at least one unique asset identifier to the controller 68, the at least one unique asset identifier is presented using a second communication protocol, wherein the second communication protocol is different from the first communication protocol. Non-limiting examples of the second communication protocol may include a 1-wire communication protocol (such as, but not limited to the Dallas Semiconductor 1-Wire Protocol), a communication bus protocol, an RF protocol, a Bluetooth protocol, a USB protocol, a firewire protocol, a serial protocol, a parallel protocol, and an optical protocol. The controller 68 of FIG. 3 may be part of a security asset manager (SAM) or other security system. Such security systems typically have a single or limited number of communication protocols, the Dallas Semiconductor 1-Wire Protocol being just one possible example. Using the asset tracking device 58, such as embodied here, or its equivalent, the presence or absence of an asset can be tracked by a security system's controller without the need to add a tracking device to the asset that is compatible with the controller's communication protocol. For example, in the past, for security systems having a 1-Wire communication bus, it has been necessary to attach a 1-Wire-compatible Touch Memory Button of approximately a 0.5 inch diameter and 0.25 inch thickness to an asset desired to be tracked by the 1-Wire based security system. For larger assets, such as tools and tool boxes, adding a smart button to the asset typically does not interfere with the operation of the asset. However, it is not desirable to add such a large tracking device to smaller assets. For example, most users would find it cumbersome to have a large button attached to a smartphone or tablet device. In fact, it would be preferable to have a method and system to enable such devices to be tracked by the security system's controller without needing to add elements to the asset at all. The asset tracking device 58 of FIG. 3 enables a security system with one protocol to track an asset having a second protocol without needing to modify the asset, as long as the asset can communicate via a protocol compatible with the tracking communication port 60 as supported by the translation circuitry 66.

In other situations, the asset tracking device 58 can also be helpful, even if the asset to be tracked does not have an integral asset communication port 62. In such a case, an asset communication port 62 may be added to the asset 64. However, instead of being limited to adding a larger touch memory button compatible with the security system, a more compact and/or lower profile asset communication port 62 may be added to the asset. As just one example, an RFID tag may be added to the asset. The RFID tag, whether passive or active can act as an asset communication port 62 by responding to queries from an RFID enabled tracking communication port 60. The response from the RFID tag can include a unique asset identifier. Those skilled in the art will see that the translation circuitry 66 can remove a unique asset identifier from the RFID tag transmission packaging and present the unique asset identifier to the controller via a different protocol compatible with the controller.

The translation circuitry 66 may include a microprocessor, an application specific integrated circuit (ASIC), a field programmable gate array (FPGA), a computer, digital components, analog components, or any combination and/or plurality thereof

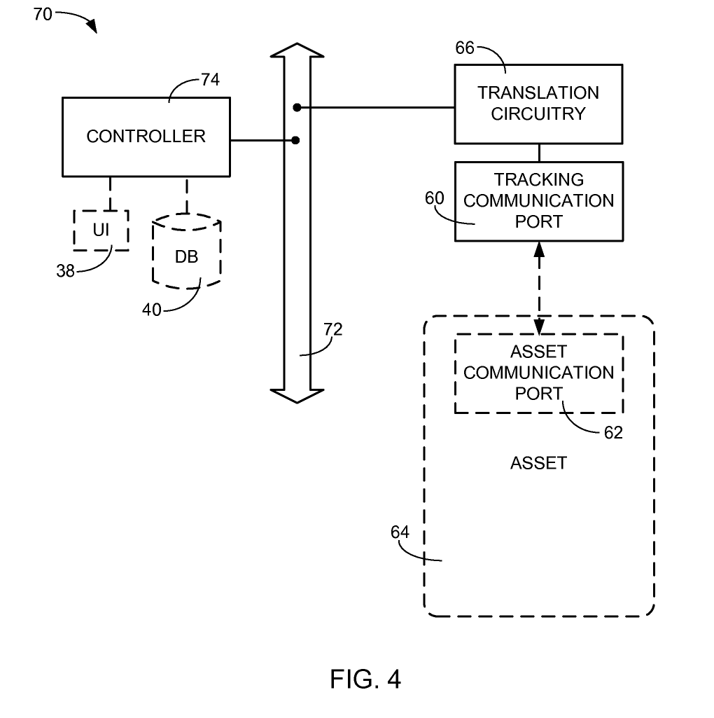

FIG. 4 schematically illustrates one embodiment of a security asset manager (SAM) 70 having a communication bus 72. As one example, the communication bus 72 may be a 1-Wire communication bus compatible with the Dallas Semiconductor 1-Wire protocol. The SAM 70 also has at least one tracking communication port 60 configured to be removably coupled to an asset communication port 62. The asset communication port 62 is coupled to an asset 64, and neither the asset 64 nor its asset communication port 62 are part of the SAM 70. The features of the tracking communication port 60, the asset communication port 62, and the asset 64 have been discussed above with regard to other embodiments.

The SAM 70 also has translation circuitry 66 coupled to the at least one tracking communication port 60 and the communication bus 72. The translation circuitry 66 is configured to sense when an asset 64, having the asset communication port 62, couples to the at least one tracking communication port 60 via its asset communication port 62. The translation circuitry 66 is also configured to query the asset 64 for at least one unique asset identifier. This query and the at least one unique asset identifier have also been discussed above. The translation circuitry 66 is further configured to present the at least one unique asset identifier to a controller 74, in this case, via the communication bus 72. In the case where the communication bus 72 is a 1-wire bus compatible with the Dallas Semiconductor 1-Wire Protocol, presenting the at least one unique asset identifier to the controller includes packaging the at least one unique asset identifier within one or more bytes formatted to comply with the Dallas Semiconductor 1-Wire Protocol and transmitting the one or more bytes to the communication bus 72.

The SAM 70 also has a controller 74 coupled to the communication bus 72 and configured to determine when the asset communication port 62 (and therefore the asset 64) is coupled to the at least one tracking communication port 60 by receiving the asset's at least one unique asset identifier from the communication bus 72. The at least one unique asset identifier can be the identifier received from the asset or it can be another unique identifier mapped to the device's unique identifier. For example, in the case of the Dallas Semiconductor 1-Wire Protocol, the protocol provides a way, known to those skilled in the art, of recovering the unique 64 bit addresses of every device on the bus. In some embodiments involving a 1-wire bus, the translation circuitry can be configured to associate one of the unique 64-bit addresses with an asset's unique identifier. In such an embodiment, presenting the unique asset identifier to the controller may be accomplished by presenting a second unique identifier to the controller, because the second unique identifier is uniquely mapped to the unique asset identifier. The translation circuitry may maintain a mapping of second unique identifiers as they correspond to unique asset identifiers, the controller may maintain such a mapping, the controller and the translation circuitry may access such a mapping remotely stored from both, and/or any combination thereof. In other embodiments, presenting the at least one unique asset identifier to the communication bus 72 may simply mean the translation circuitry reports or responds to the controller that an asset, identified to the translation circuitry by the unique asset identifier, is present. Thus, in some embodiments, the translation circuitry may present the unique asset identifier to the controller (in some cases via a communication bus) such that the unique asset identifier is abstracted to the controller, but nonetheless uniquely identifies presence or absence of the asset to the controller.

As with previous embodiments, the controller 74 of the SAM 70 may also be coupled to a user interface 38 and/or a database 40, the features of which have been discussed above.

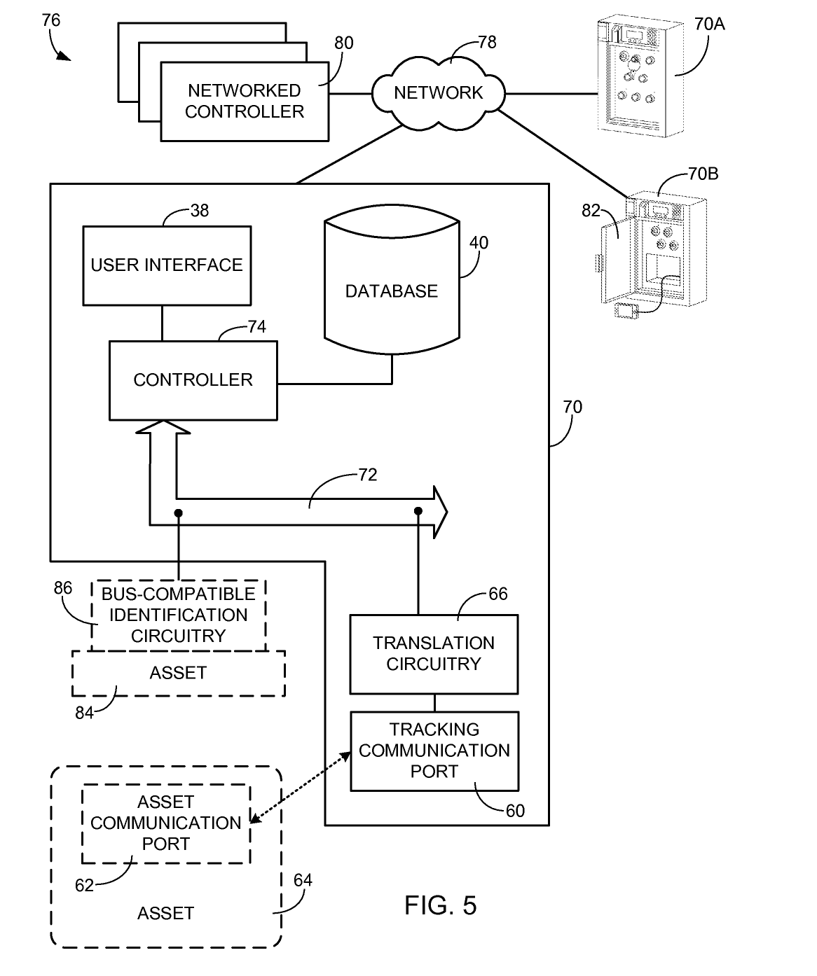

FIG. 5 schematically illustrates a further embodiment of a system for asset management 76. The system 76 includes a security asset manager (SAM) 70, the features of which have been discussed above. The SAM 70 may be coupled to and/or in communication with one or more other SAMs 70A, 70B via a network 78. One or more networked controllers 80 may also be coupled to one or more SAMs via the network 78. The network 78 may be, but is not limited to, a local area network (LAN), a wide area network (WAN), a wireless LAN, a wireless WAN, or any combination or plurality thereof. In some embodiments, one of the one or more networked controllers 80 may be a server running asset management software for coordinating and collecting data from one or more SAMs, as well as providing reports on authorized user activity, asset status, and alarms. One suitable example of asset management software is the Global Facilities Management System (GFMS) software available from Key Systems, Inc. In other embodiments, another of the one or more networked controllers 80 may include, but are not limited to, a computer, a laptop, a smartphone, and/or a cellular phone which is able to interact via a browser or other web enabled client with either a remote server running asset management software or an embedded web server in one of the SAMs. Depending on the embodiment, the SAM 70B may have a door 82 which may be locked and then unlocked by the SAM 70B following user identification. Other embodiments may have one or more other doors which can act as electronically controllable lockers and/or provide controlled access to one or more assets. Some embodiments may not have a door at all.

The SAM 70 may be configured such that assets 84 having bus-compatible identification circuitry 86 attached to them (such as an iButton from Dallas Semiconductor) may be coupled directly to the communication bus 72, since the bus-compatible identification circuitry 86 uses the same communication protocol as the communication bus 72. Thus, assets with bus-compatible identification circuitry 86 may be monitored for presence and removal by the controller 74 coupled to the communication bus 72. Other assets, such as asset 64 with an asset communication port 62 that does not communicate using the protocol of the communication bus 72 may be tracked as already described in the embodiments above, via a coupling (wired or wireless) with the tracking communication port 60 as controlled by the translation circuitry 66.

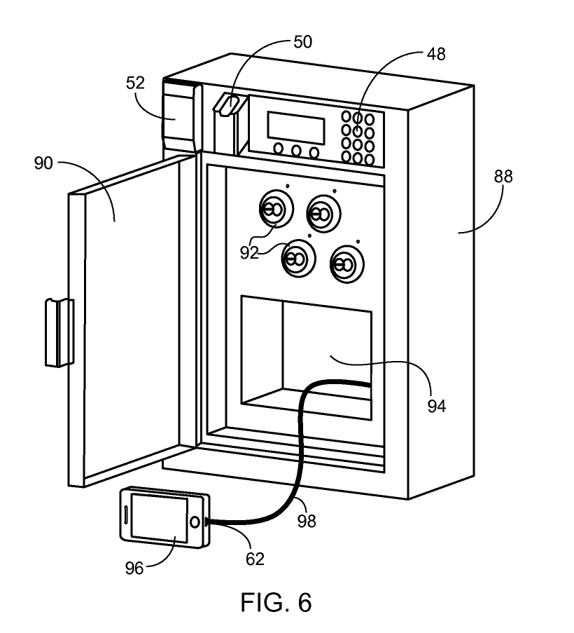

FIGS. 6-9 schematically illustrate different embodiments of a security asset manager (SAM). FIG. 6 shows a SAM 88 embodiment having a keypad 48, a fingerprint reader 50, and a proximity card reader 52 as discussed previously as part of the user interface. The SAM 88 also has a door 90 which may be locked and then unlocked by the SAM 88 following authorized user identification via one or more of the user interface options. In this embodiment, behind the door 90, authorized users will be able to reach one or more electronically addressable key entrapment cylinders 92 which appear as locks on the outside but when a key matching the cylinder is inserted into the cylinder, the system may entrap the key as is known by those skilled in the art. The controller (not shown), in the SAM 88, can release certain entrapped keys to authorized users as well as monitor whether or not a key has been removed or returned using a suitable sensor such as, but not limited to, a pressure switch, a contact switch, or a photoelectric switch. Such features are known to those skilled in the art, but can be combined with the disclosed and claimed invention. The SAM 88 also has a cavity 94, behind the door 90, sized to hold one or more assets. In this embodiment, the cavity 94 is sized to accommodate a smartphone (asset) 96. A cable 98 is provided to couple the asset communication port 62 to a tracking communication port (not shown) of the SAM 88. The operation and features of the tracking communication port and the asset communication port 62 have been discussed in embodiments above. The asset 96 is shown outside of the cavity 94 in order to make the cable 98 more visible, but the asset 96 and the cable 98 may be placed into the cavity 94 and the door 90 closed to keep them secure. As described previously, only authorized users will be able to open the door 90, and the presence or absence of the asset 96 can be tracked by the SAM 88, thus enabling the SAM 88 to keep a log of which authorized user has removed or returned the asset 96, or if an authorized user has removed an asset 96 which he/she was not entitled to remove.

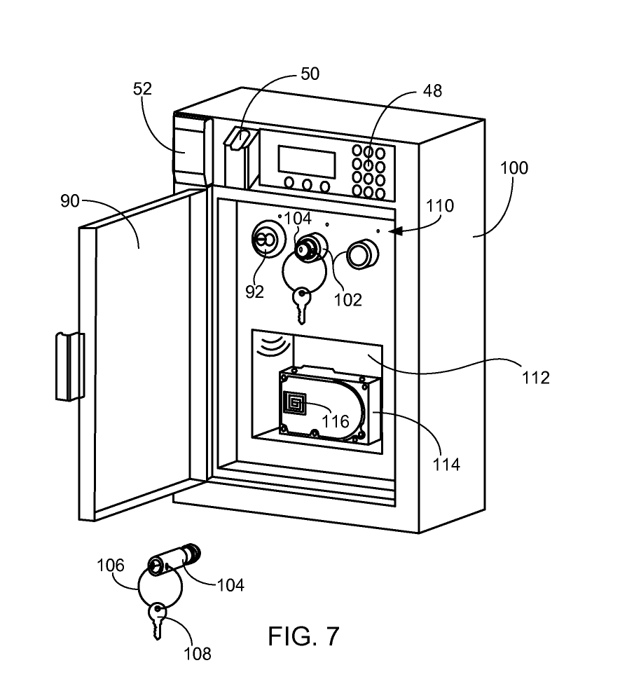

FIG. 7 shows a SAM 100 embodiment having a keypad 48, a fingerprint reader 50, and a proximity card reader 52 as discussed previously as part of the user interface. The SAM 100 also has a door 90 which may be locked and then unlocked by the SAM 100 following the user identification via one or more of the user interface options. In this embodiment, behind the door 90, authorized users will be able to reach one or more electronically addressable key entrapment cylinders 92 as discussed above. Also in this embodiment, authorized users will be able to reach one or more receptacles 102 which are sized to accept a latchable plug 104. In some embodiments, the latchable plug 104 may be attached to a key ring 106 for holding one or more keys 108. Other types of assets may also be coupled to the latchable plug 104. The latchable plugs 104 may be selectively entrapped/released by the receptacle 102 by the SAM controller for authorized users. A light source 110 may be provided, corresponding to each receptacle 102 or cylinder 92, so that a user's attention may be drawn to a particular asset/location. As just one example, the light source 110 may be illuminated to indicate that a user, properly identified to the SAM 100, is authorized to remove the corresponding asset at the lit position. The SAM 100 also has a cavity 112, behind the door 90, sized to hold one or more assets. In this embodiment, the cavity 112 is sized to accommodate a hard drive (asset) 114. An RFID tag 116 is attached to the asset 114. In this embodiment, the RFID tag 116 operates as an asset communication port for the asset 114. The SAM 100 has an RFID-compatible tracking communication port that can wirelessly query the RFID tag (asset communication port) for a unique asset identifier. The operation and features of the tracking communication port and the asset communication port 116 have been discussed in embodiments above. The asset 114 may be placed into the cavity 112 and the door closed to keep them secure. As described previously, only authorized users will be able to open the door 90, and the presence or absence of the asset 114 can be tracked by the SAM 100, thus enabling the SAM to keep a log of which authorized user has removed or returned the asset, or if an authorized user has removed an asset which he/she was not entitled to remove.

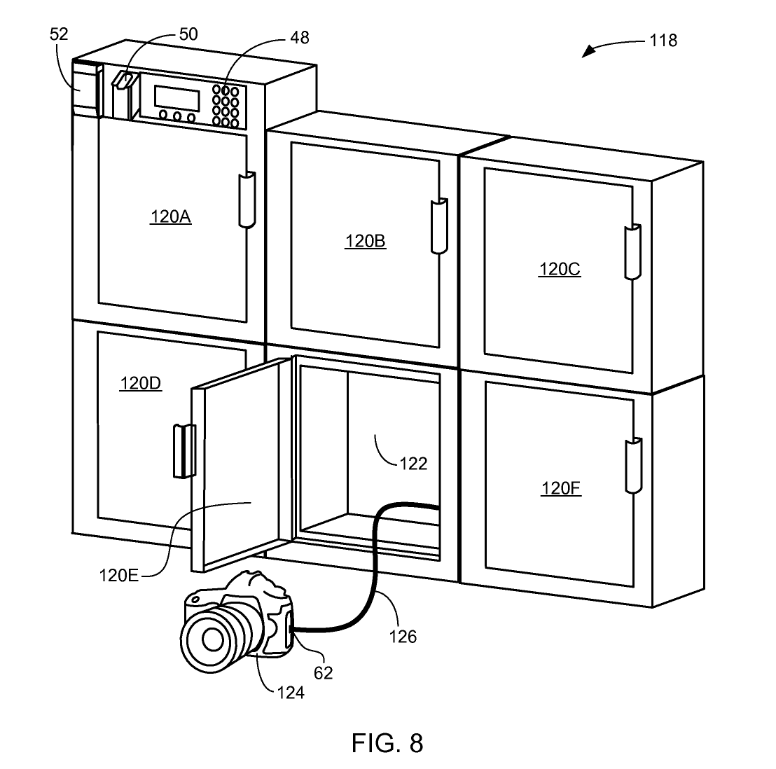

FIG. 8 shows a SAM 118 embodiment having a keypad 48, a fingerprint reader 50, and a proximity card reader 52 as discussed previously as part of the user interface. The SAM 118 also has a plurality of locker doors 120A-120F which may be individually locked and then unlocked by the SAM 118 following the user identification via one or more of the user interface options. The SAM 118 may be configured to open one or more of the locker doors 120A-120F for a user, depending on his/her authorization. In this embodiment, behind the locker door 120E, authorized users will be able to reach a locker cavity 122 sized to hold one or more assets. In this embodiment, the cavity 122 is sized to accommodate a camera (asset) 124. A cable 126 is provided to couple the asset communication port 62 to a tracking communication port (not shown) of the SAM 118. The operation and features of the tracking communication port and the asset communication port 62 have been discussed in embodiments above. The asset 124 is shown outside of the cavity 122 in order to make the cable 126 more visible, but the asset 124 and the cable 126 may be placed into the locker cavity 122 and the locker door 120E closed to keep them secure. Any given locker 120A-120F may have one or more tracking communication ports, depending on the desired configuration and the number and type of assets to be tracked for each locker. As described previously, only authorized users will be able to open one or more of the locker doors 120A-120F, and the presence or absence of assets therein can be tracked by the SAM 118, thus enabling the SAM to keep a log of which authorized user has removed or returned the asset, or if an authorized user has removed an asset which he/she was not entitled to remove. Furthermore, with lockers, each authorized user may be assigned a single locker, thereby reducing the opportunity for one authorized user to remove another authorized user's assets.

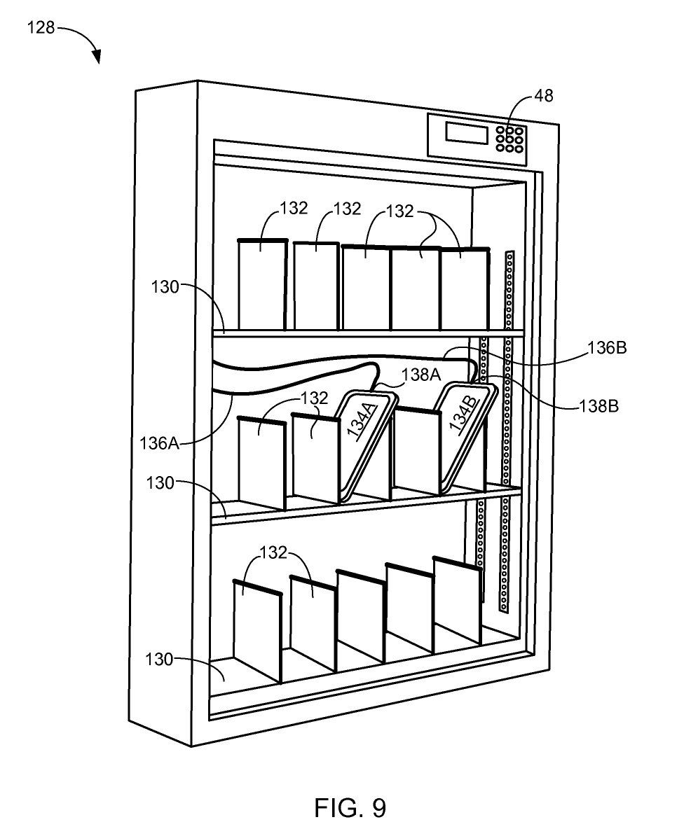

FIG. 9 shows a SAM 128 embodiment having a keypad 48 as discussed previously as part of the user interface. The SAM 128 may also have a door (not shown) which may be locked and then unlocked by the SAM 128 following the user identification via the user interface. The SAM 128 has shelves 130 and partitions 132 organized to support and store tablet computing devices, such as, but not limited to an Apple iPad, a Samsung Galaxy, a Google Nexus, a Blackberry Playbook, and a Windows 8 tablet. Two example tablets 134A, 134B are shown. Cables 136A, 136B are provided to couple each asset's communication port 138A, 138B to corresponding tracking communication ports (not shown) of the SAM 128. The operation and features of the tracking communication ports and the asset communication ports 138A, 138B have been discussed in embodiments above. As described previously, only authorized users will be able to open the door (not shown), and the presence or absence of one or more assets 134A, 134B can be tracked by the SAM 128, thus enabling the SAM to keep a log of which authorized user has removed or returned the asset, or if an authorized user has removed an asset which he/she was not entitled to remove.

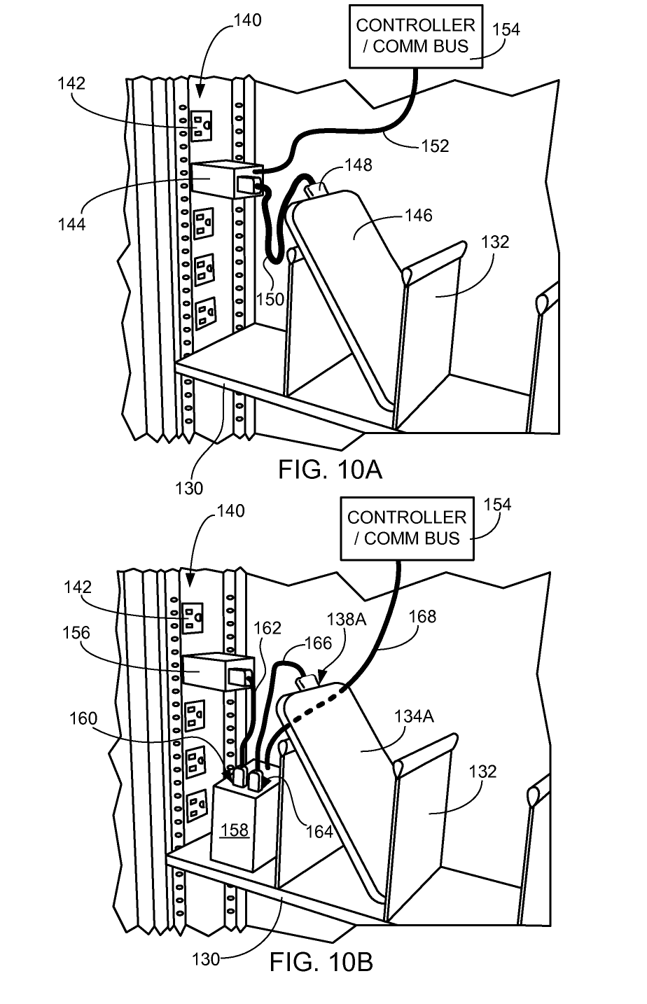

With assets such as, but not limited to, smartphones and tablet computing devices, it is often the case that the communication cable which plugs into the asset (to couple to the asset communication port) also provides power to the asset for charging its battery. In light of this, FIGS. 10A-10B schematically illustrate connection embodiments for a security asset manager (SAM). In the embodiment of FIG. 10A, the SAM is provided with one or more power strips 140, having one or more electrical outlets 142. A power supply 144 having a casing 145 may be provided to tap into a power outlet 142 and provide appropriate charging voltage/current to an asset 146 via the asset communication port connector 148. The same cable 150 which provides charging power to the asset 146 can also pass-through or otherwise provide communication from the asset communication port to a tracking communication port housed inside the power supply casing 145. The power supply casing may also include the translation circuitry coupled to the tracking communication port. A second cable 152 may be provided to couple the translation circuitry in the power supply casing 145 to a controller or communication bus 154, thereby enabling asset tracking as described in the embodiments above while also providing charging to the asset 146.

Similarly, in the embodiment of FIG. 10B, the SAM is provided with one or more power strips 140, having one or more outlets 142. A standard power supply 156, such as the power supply provided by the tablet/smartphone/asset manufacturer for charging the electronic device, may be plugged into a power outlet 142. An asset tracking device 158 has a connection 160 configured to receive power from the standard power supply 156, for example, via a first cable 162. The asset tracking device 158 houses a tracking communication port and translation circuitry, such as has been discussed previously. The asset tracking device 158 has a connection configured to couple the tracking communication port to the asset communication port, for example via a second cable 166. A third cable 168 may be provided to couple the translation circuitry in the asset tracking device 158 to a controller or communication bus 154, thereby enabling asset tracking as described in the embodiments above. Charging power may also be passed through the second cable/connection 166 from the standard power supply 156. Such an embodiment enables end-user flexibility to use any desired electronic device, provided it has an asset communication port compatible with the tracking communication port of the asset tracking device 158, without regard for charging power requirements, since the appropriate charging levels may be provided by the asset's own power supply as passed through the asset tracking device 158.

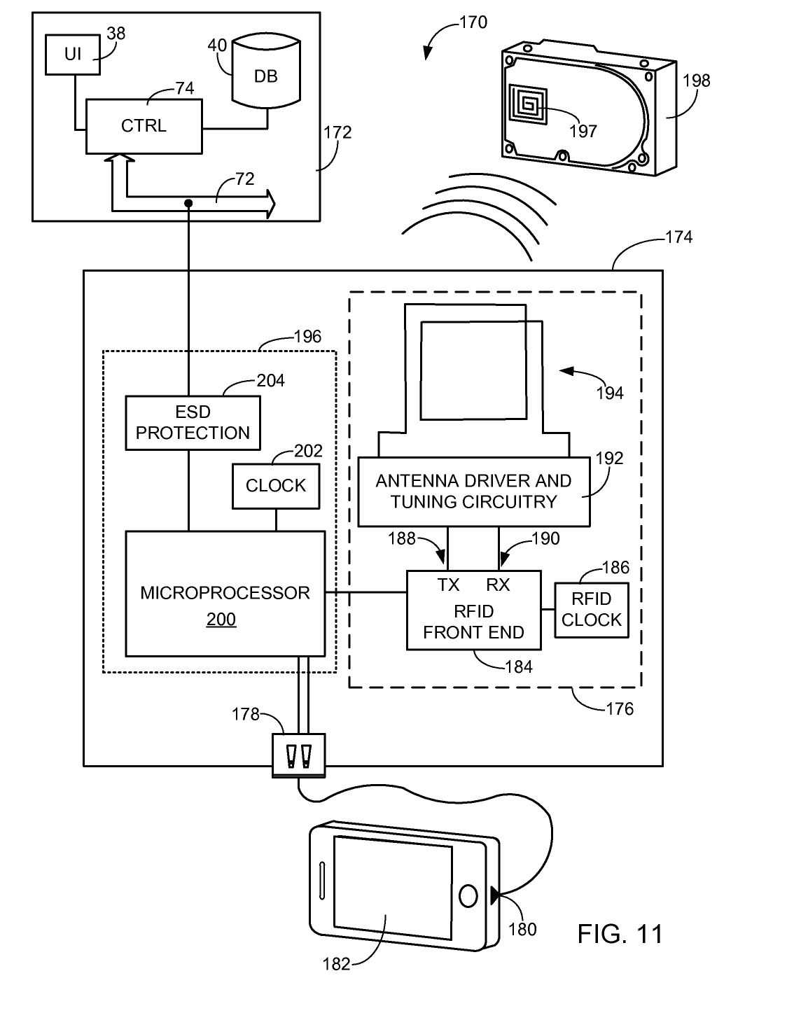

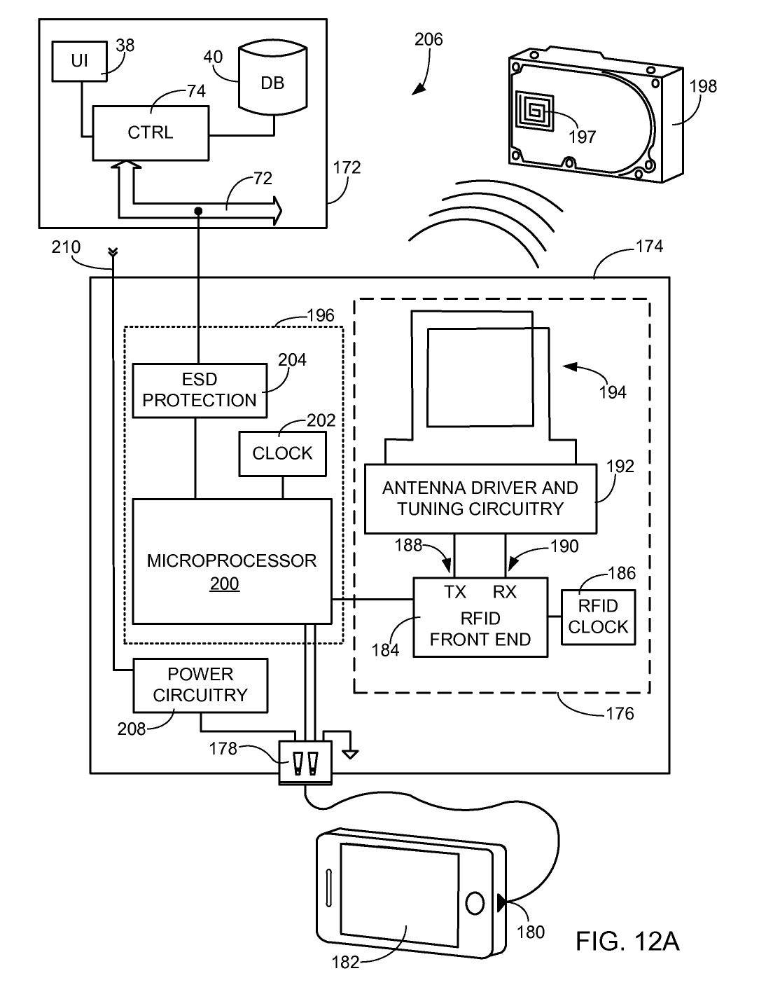

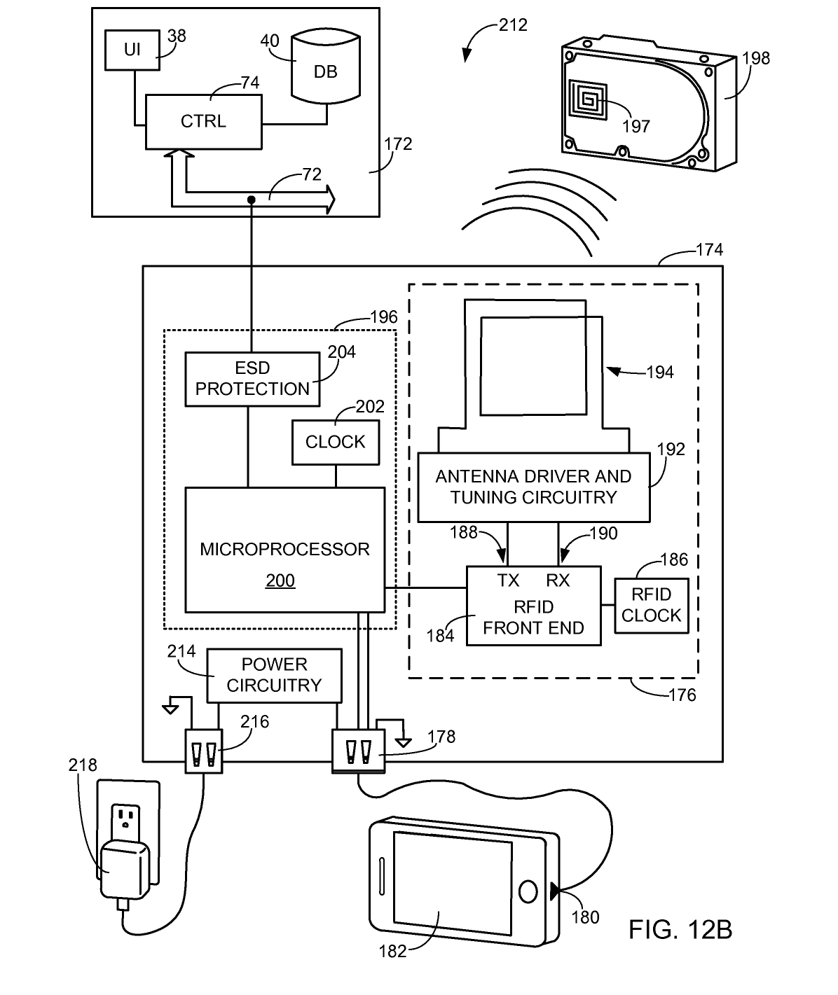

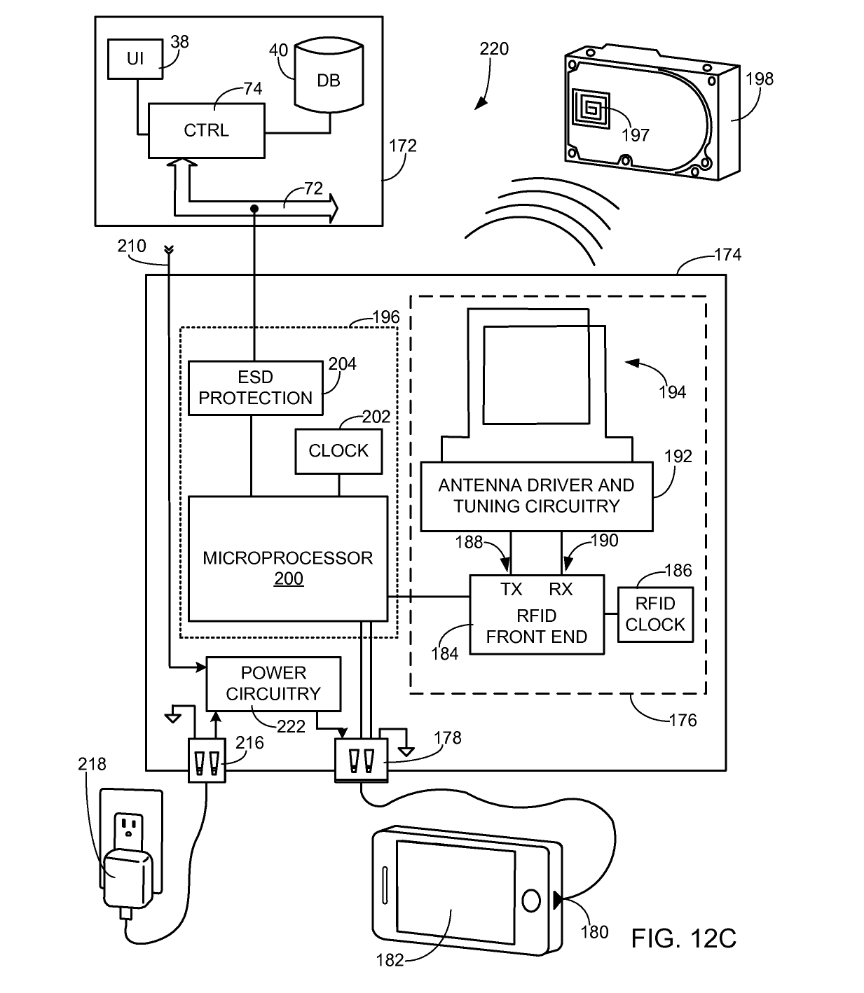

FIGS. 11-12C schematically illustrate embodiments of a system for asset management having universal serial bus (USB) and radio frequency identification (RFID) tracking communication ports. As shown in FIG. 11, the embodied system for asset management 170 has a security asset manager (SAM) 172 having a controller 74 with a user interface 38 and a database 40 both coupled to the controller 74 as discussed in embodiments above. The SAM 172 also has a communication bus 72, such as, but not limited to a Dallas Semiconductor 1-Wire Bus as also discussed above. The system 170 also has an asset tracking device 174. In this embodiment, the asset tracking device 174 has two tracking communication ports: an RFID compatible tracking communication port 176 and a USB tracking communication port 178. The USB tracking communication port 178 is configured to be removably coupled to a USB asset communication port 180 for an asset 182. The RFID compatible tracking communication port 176 includes an RFID front end 184, for example, but not limited to the Multi-Standard Fully Integrated RFID Analog Front End model TRF7960 from Texas Instruments. The RFID compatible tracking communication port 176 also has an RFID clock 186 coupled to the RFID front end 184 to provide a clock at the desired RFID communication frequency. Those skilled in the art are easily familiar with many clock circuits which can provide a desired RFID clock frequency. A transmit connection 188 and a receive connection 190 of the RFID front end 184 are coupled to antenna driver and tuning circuitry 192, which is further coupled to an antenna 194. In this embodiment, the same antenna is used for transmission and reception, however other embodiments may utilize separate transmission and reception antennas. The RFID tracking communication port 176 can be wirelessly coupled with an asset communication port, such as RFID tag 197, on an asset 198. The asset tracking device 174 also has translation circuitry 196 coupled to the tracking communication ports 176, 178. In this embodiment, the translation circuitry 196 includes a microprocessor 200 coupled to the USB tracking communication port 178 and the RFID front end 184 of the RFID tracking communication port 176. The microprocessor 200 may be suitably programmed to sense when an asset 182, 198 couples to a tracking communication port via the asset communication port. The microprocessor 200 may also be programmed to query the asset 182 via the USB tracking communication port 178 and/or the asset 198 via the RFID tracking communication port 176 for at least one unique asset identifier. In this embodiment, the translation circuitry 196 may also include a clock 202 coupled to the microprocessor 200. The translation circuitry 196 may further include electrostatic discharge (ESD) protection 204 for a communication connection between the microprocessor 200 and the communication bus 72 of the SAM 172. One non-limiting example for suitable ESD protection 204 is the ESD Protection Device for 1-Wire Interfaces, model DS9503 from Maxim Integrated. Some embodiments may not have ESD protection. One non-limiting example of a suitable microprocessor 200 is the model PIC24FJ256GB110 microprocessor from Microchip Technology Incorporated. In this embodiment, the microprocessor 200 can present the at least one unique asset identifier to the controller 74 via the ESD protection 204 and as facilitated by the communication bus 72 coupled to the controller 74 as has been discussed previously.

Some of the assets 182 which are coupled to the asset tracking device 174 in the system for asset management 170, will be able to be charged over the tracking communication port to asset communication port connection when coupled. FIG. 12A schematically illustrates another embodiment of a system for asset management 206, similar to the system from FIG. 11. The asset tracking device 174 in the system of FIG. 12A, however, also has power circuitry 208 configured to receive power from at least one external power connection. In this embodiment, the at least one external power connection includes a voltage supply pin 210. The voltage supply pin 210 may be configured to receive its power from a variety of sources, including a connection from SAM 172. Those skilled in the art can choose from a variety of power circuitry 208 topologies to condition, if necessary, and pass through power to the tracking communication port. In the case where the tracking communication port is a USB tracking communication port 178, five volts may be provided to the USB V_{CC} pin as known by those skilled in the art, thereby providing charging capability in addition to tracking capability for the coupled asset.

FIG. 12B schematically illustrates another embodiment of a system for asset management 212, similar to the system from FIG. 11. The asset tracking device 174 in the system of FIG. 12B, however, also has power circuitry 214 configured to receive power from at least one external power connection. In this embodiment, the at least one external power connection includes a USB power connector 216. The USB power connector 216 may be configured to receive its power from a variety of sources, including a connection from a USB power supply 218. While not necessary, the USB power supply 218 may be the power supply provided by the asset 182 manufacturer for the asset 182. Those skilled in the art can choose from a variety of power circuitry 214 topologies to condition, if necessary, and pass through power to the tracking communication port 178. In the case where the tracking communication port is a USB tracking communication port 178, five volts may be provided to the USB V_{CC} pin as known by those skilled in the art, thereby providing charging capability in addition to tracking capability for the coupled asset.

FIG. 12C schematically illustrates a further embodiment of a system for asset management 220, similar to the system from FIG. 11. The asset tracking device 174 in the system of FIG. 12C, however, also has power circuitry 222 configured to receive power from at least one external power connection. In this embodiment, the at least one external power connection includes a voltage supply pin 210 and a USB power connector 216, the features of which have been discussed above. Those skilled in the art can choose from a variety of power circuitry 222 topologies to condition, if necessary, and pass through power to the tracking communication port. In the case where the tracking communication port is a USB tracking communication port 178, five volts may be provided to the USB V_{CC} pin as known to those skilled in the art, thereby providing charging capability in addition to tracking capability for the coupled asset.

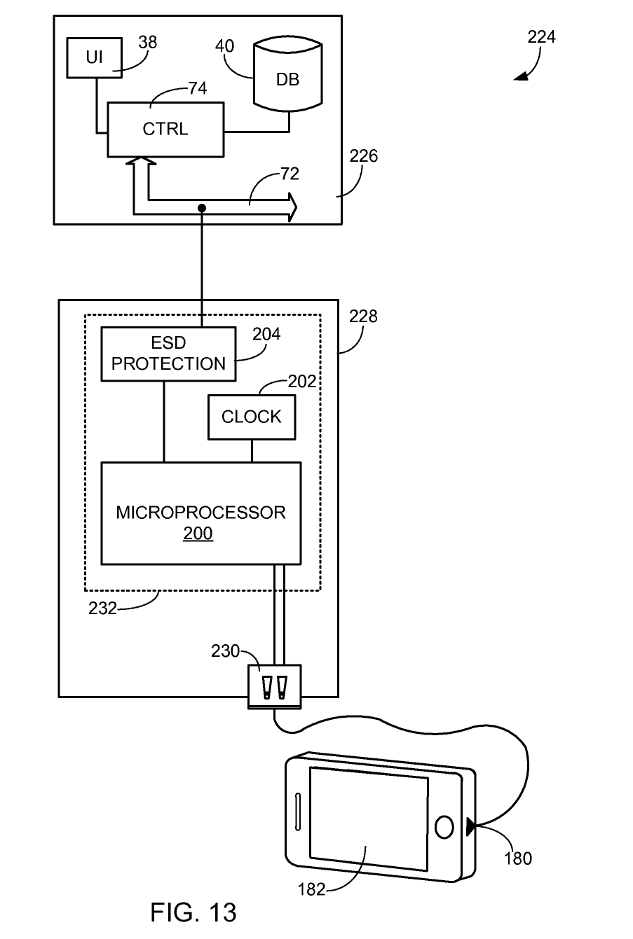

FIG. 13 schematically illustrates one embodiment of a system for asset management 224 having a USB tracking communication port. As shown in FIG. 13, the embodied system for asset management 224 has a security asset manager (SAM) 226 having a controller 74 with a user interface 38 and a database 40, both coupled to the controller 74 as discussed in embodiments above. The SAM 226 also has a communication bus 72, such as, but not limited to a Dallas Semiconductor 1-Wire Bus as also discussed above. The system 224 further has an asset tracking device 228. In this embodiment, the asset tracking device 228 has a USB tracking communication port 230. The USB tracking communication port 230 is configured to be removably coupled to a USB asset communication port 180 for an asset 182. The asset tracking device 228 also has translation circuitry 232 coupled to the tracking communication port 230. In this embodiment, the translation circuitry 232 includes a microprocessor 200 coupled to the USB tracking communication port 230. As discussed previously, the microprocessor 200 may be suitably programmed to sense when an asset communication port 180 of asset 182 couples to the tracking communication port 230, and query the asset communication port 182 via the USB tracking communication port 230 for at least one unique asset identifier. In this embodiment, the translation circuitry 232 may also include a clock 202 coupled to the microprocessor 200. The translation circuitry 232 may further include electrostatic discharge (ESD) protection 204 for a communication connection between the microprocessor 200 and the communication bus 72 of the SAM 226. As discussed previously, one non-limiting example for suitable ESD protection 204 is the ESD Protection Device for 1-Wire Interfaces, model DS9503 from Maxim Integrated. One non-limiting example of a suitable microprocessor 200 is the model PIC24FJ256GB110 microprocessor from Microchip Technology Incorporated. The microprocessor 200 can present the at least one unique asset identifier to the controller 74 via the ESD protection 204 and as facilitated by the communication bus 72 coupled to the controller 74 as has been discussed previously.

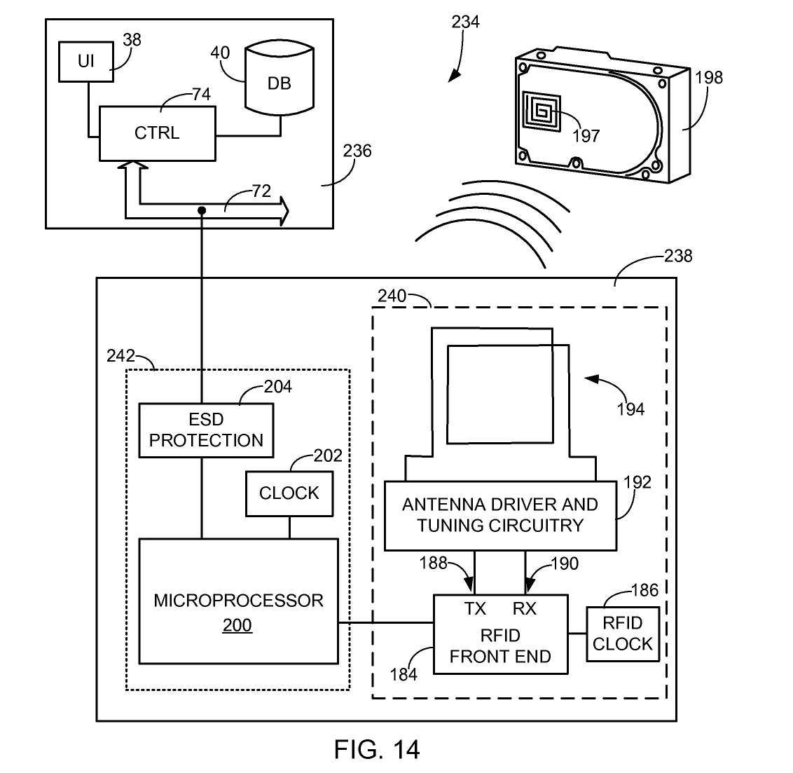

FIG. 14 schematically illustrates one embodiment of a system for asset management 234 having an RFID tracking communication port. As shown in FIG. 14, the embodied system for asset management 234 has a security asset manager (SAM) 236 having a controller 74 with a user interface 38 and a database 40 both coupled to the controller 74 as discussed in embodiments above. The SAM 236 also has a communication bus 72, such as, but not limited to a Dallas Semiconductor 1-Wire Bus as also discussed above. The system 234 also has an asset tracking device 238. In this embodiment, the asset tracking device 238 has an RFID tracking communication port 240. The RFID tracking communication port 240 includes an RFID front end 184 and an RFID clock 186 coupled to the RFID front end 184 to provide a clock at the desired RFID communication frequency, as discussed previously. A transmit connection 188 and a receive connection 190 of the RFID front end 184 are coupled to antenna driver and tuning circuitry 192, which is further coupled to an antenna 194 as also discussed previously. The RFID tracking communication port 240 can be wirelessly coupled with an asset communication port, such as RFID tag 197, on an asset 198. The asset tracking device 238 also has translation circuitry 242 coupled to the tracking communication port 240. In this embodiment, the translation circuitry 242 includes a microprocessor 200 coupled to the RFID front end 184 of the RFID tracking communication port 240. The microprocessor 200 may be suitably programmed to sense when an asset 198 couples to a tracking communication port, and query the asset communication port via the RFID tracking communication port 240 for at least one unique asset identifier. In this embodiment, the translation circuitry 242 may also include a clock 202 coupled to the microprocessor 200. The translation circuitry 242 may further include electrostatic discharge (ESD) protection 204 for a communication connection between the microprocessor 200 and the communication bus 72 of the SAM 236. One non-limiting example for suitable ESD protection 204 is the ESD Protection Device for 1-Wire Interfaces, model DS9503 from Maxim Integrated. One non-limiting example of a suitable microprocessor 200 is the model PIC24FJ256GB110 microprocessor from Microchip Technology Incorporated. The microprocessor 200 can present the at least one unique asset identifier to the controller 74 via the ESD protection 204 and as facilitated by the communication bus 72 coupled to the controller 74 as has been discussed previously.

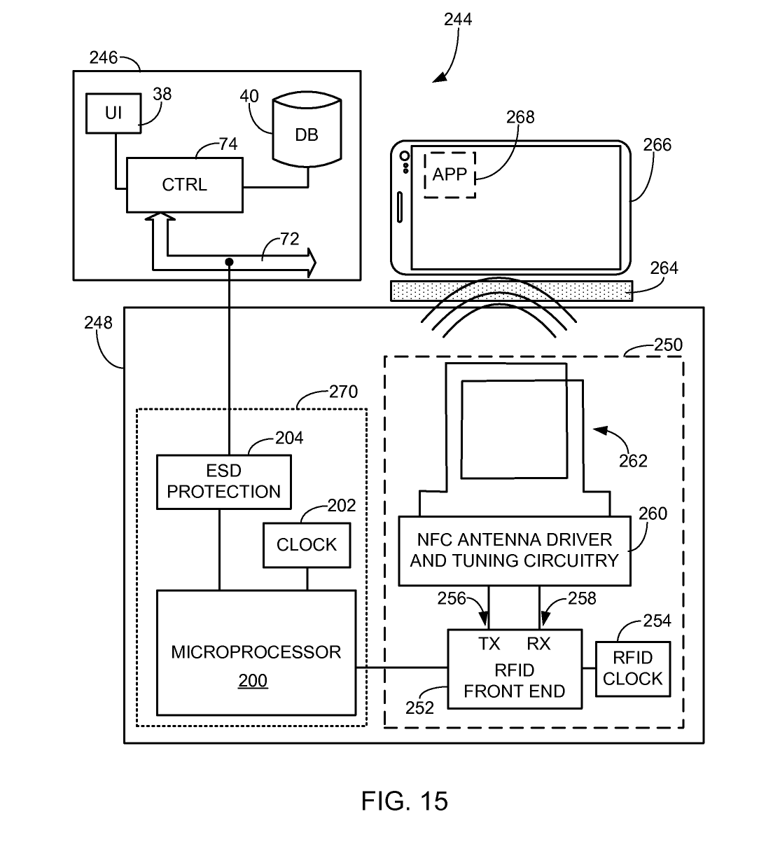

FIG. 15 schematically illustrates one embodiment of system for asset management 244 having a near field communication (NFC) tracking communication port. As shown in FIG. 15, the embodied system for asset management 244 has a security asset manager (SAM) 246 having a controller 74 with a user interface 38 and a database 40 both coupled to the controller 74 as discussed in embodiments above. The SAM 246 also has a communication bus 72, such as, but not limited to a Dallas Semiconductor 1-Wire Bus as also discussed above. The system 244 also has an asset tracking device 248. In this embodiment, the asset tracking device 248 has a near field communication (NFC) tracking communication port 250. The NFC tracking communication port 250 includes an RFID front end 252, for example, but not limited to the Multi-Standard Fully Integrated 13.56 MHz RFID Analog Front End model TRF7960 from Texas Instruments. The NFC tracking communication port 250 also has an RFID clock 254 coupled to the RFID front end 252 to provide a clock at the desired NFC communication frequency which is typically, but not exclusively 13.56 MHz. Those skilled in the art are easily familiar with many clock circuits which can provide a desired RFID clock frequency. A transmit connection 256 and a receive connection 258 of the RFID front end 252 are coupled to NFC antenna driver and tuning circuitry 260, which is further coupled to an NFC antenna 262. In this embodiment, the same antenna is used for transmission and reception, however other embodiments may utilize separate transmission and reception antennas. Since NFC typically occurs over very short distances, it may also be helpful to include an NFC alignment pad 264 to show a user where to place their asset 266. Suitable examples of an NFC alignment pad include, but are not limited to marks on a surface, one or more stickers or decals, a holding slot, or an actual pad. The NFC tracking communication port 250 can be wirelessly coupled with an asset communication port, such as an NFC port (not shown) on an asset 266. Many assets include NFC ports, such as, but not limited to smartphones. With some assets having NFC ports, the asset tracking device 248 may be able to query the asset over the NFC connection for a unique asset identifier without modifying the asset. Some NFC-enabled assets, however, may need a software application 268 to be installed on the asset 266 and configured to provide a unique asset identifier in response to NFC communications from the asset tracking device 248. The software application may include instructions executable by a machine (the asset) and tangibly embodied on at least one program storage device. The instructions are for performing a method of asset management, wherein the method includes monitoring an asset communication port for an identification query from a tracking communication port. The method also includes sending at least one unique identifier to the tracking communication port via the asset communication port. In the case where the tracking communication port and the asset communication port are NFC-compatible, the communications by such an application could take place wirelessly with an NFC protocol. The use of NFC protocols is well within the capabilities of those skilled in the art. The asset tracking device 248 also has translation circuitry 270 coupled to the tracking communication port 250. In this embodiment, the translation circuitry 270 includes a microprocessor 200 coupled to the RFID front end 252 of the NFC tracking communication port 250. The microprocessor 200 may be suitably programmed to sense when an asset 266 couples to the NFC tracking communication port, and query the asset 266 via the NFC tracking communication port 250 for at least one unique asset identifier. In this embodiment, the translation circuitry 270 may also include a clock 202 coupled to the microprocessor 200. The translation circuitry 270 may further include electrostatic discharge (ESD) protection 204 for a communication connection between the microprocessor 200 and the communication bus 72 of the SAM 246. One non-limiting example for suitable ESD protection 204 is the ESD Protection Device for 1-Wire Interfaces, model DS9503 from Maxim Integrated. One non-limiting example of a suitable microprocessor 200 is the model PIC24FJ256GB110 microprocessor from Microchip Technology Incorporated. The microprocessor 200 can present the at least one unique asset identifier to the controller 74 via the ESD protection 204 and as facilitated by the communication bus 72 coupled to the controller 74 as has been discussed previously.

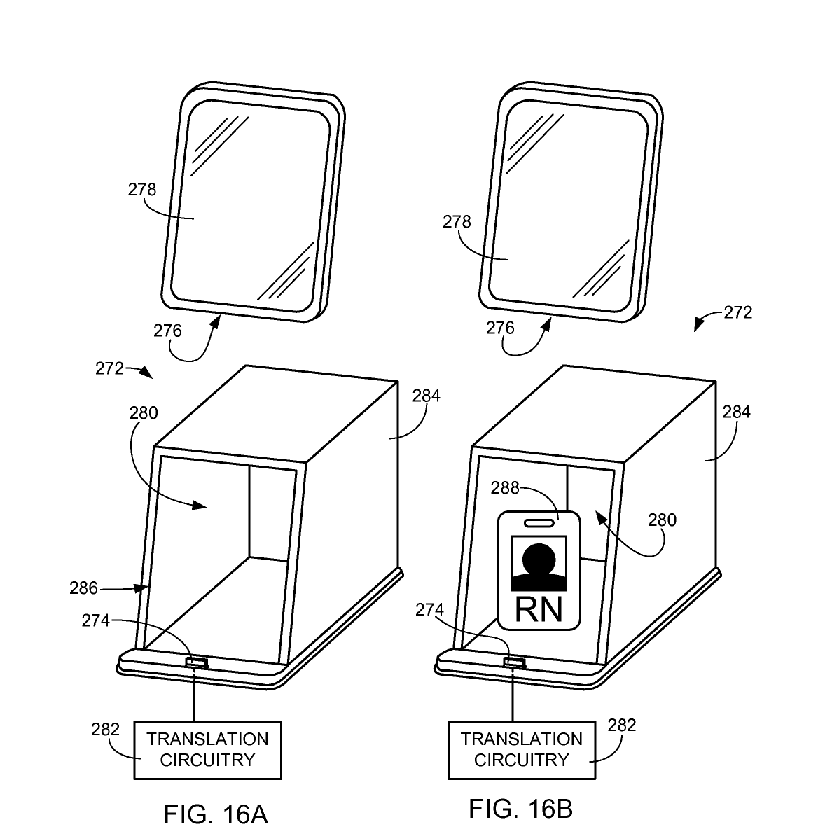

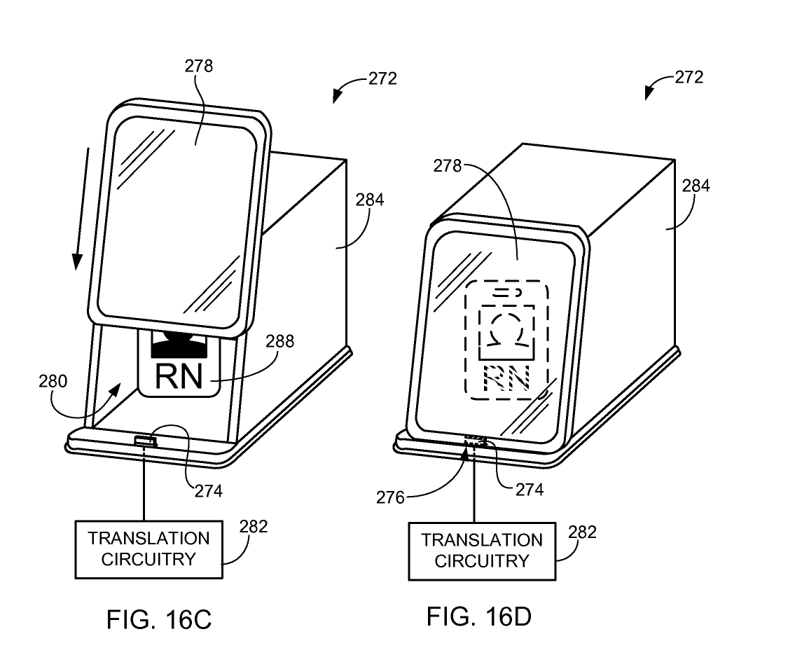

FIGS. 16A-16D schematically illustrate one embodiment of an asset management device 272 having a tracking communication port 274 positioned to couple with an asset communication port 276 such that the asset 278 prevents access to a storage cavity 280. In this embodiment, the asset 278 is illustrated as a computing tablet. It should be understood, however, that asset management devices 272 may be configured for a variety of assets, including, but not limited to smartphones, tablets, and laptops. The tracking communication port 274 is configured to be removably coupled to the asset communication port 276.

The asset management device 272 also has translation circuitry 282 coupled to the tracking communication port 274. The translation circuitry 282 is configured to sense when an asset 278, having the asset communication port 276, couples to the tracking communication port 274 via its asset communication port 276. The translation circuitry 282 is further configured to query the asset 278 for at least one unique asset identifier and present the at least one unique asset identifier to a controller (not shown), for example a controller in a security asset manager (SAM) or a local controller, either directly or indirectly, for example via a communication bus. The operation of translation circuitry, the tracking communication port, and their interaction with an asset communication port has been discussed previously with other embodiments.

The asset management device 272 also has a housing 284 having an opening 286, wherein the housing defines a storage cavity 280 accessible through the opening 286 when the asset communication port 276 is not coupled to the tracking communication port 274 and inaccessible when the asset communication port 276 is coupled to the tracking communication port 274.

For the embodiments of the asset management device illustrated in FIGS. 16A-16D, preferably, the tracking communication port 274 is a wired port such as but not limited to a USB port or a firewire port so that the physical position of the asset 278 is substantially fixed when the asset communication port 276 is coupled to the tracking communication port 274. While it is possible to utilize a wireless connection, care must be taken to configure the distance within which the wireless connection will work so that the storage cavity 280 may not be accessed while the asset communication port 276 is coupled to the tracking communication port 274. Optionally, as with previously discussed embodiments, a charging voltage may also be provided to the asset while the asset communication port 276 is coupled to the tracking communication port 274.

FIGS. 16B-16D illustrate one possible use of the asset management device 272. As shown in FIG. 16B, one or more secondary assets, such as, but not limited to the illustrated identification badge 288 may be placed within the storage cavity 280. As shown in FIG. 16C, the asset 278 is being moved towards a position where the asset communication port 276 will be coupled to the tracking communication ports 274. In some embodiments, the housing 284 may include guides to help align the asset 276 with the housing 284 and the tracking communication port 274. As shown in FIG. 16D, once the asset communication port 276 and the tracking communication port 274 are coupled, the secondary asset 288 is held within the storage cavity 280 in such a way that it is not accessible without disconnecting the asset communication port 276 from the tracking communication port 274.

Since the translation circuitry 282 is configured to present the at least one unique asset identifier to a controller when the asset is coupled to the tracking communication port (i.e. when the asset communication port is coupled to the tracking communication port), the controller (such as, but not limited to a controller in a SAM) is able to track when a certain asset is present and when it has been removed. If the asset management device 272 is in a controlled area, for example a room where an identification must be presented to a user interface in order to enter one person at a time, then if an asset is removed or returned to the asset management device, the controller can be configured to log which user removed or returned the asset and can take measures such as, but not limited to sounding an alarm or notifying a supervisor if the user removes an asset to which he/she does not have privilege.

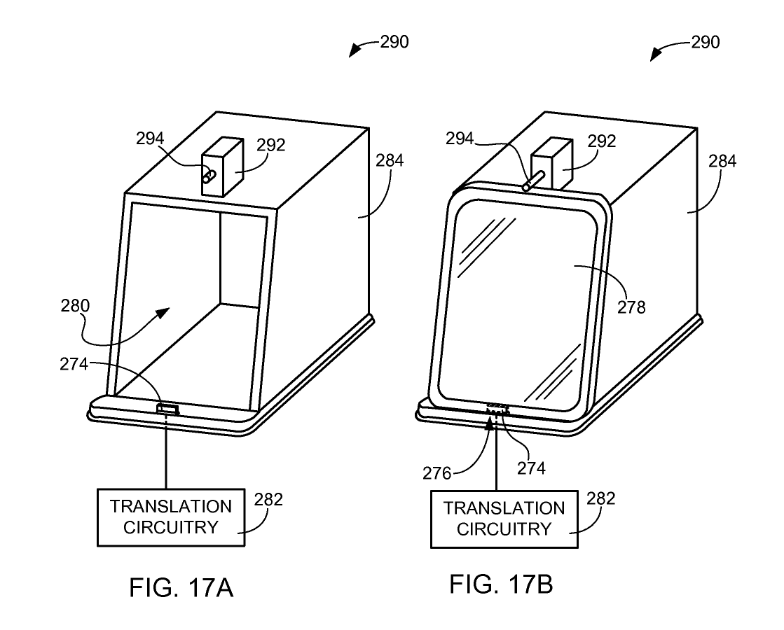

FIGS. 17A and 17B illustrate another embodiment of an asset management device 290. The asset management device 290 is similar to the asset management device 272 previously discussed with regard to FIGS. 16A-16D. The asset management device 290, shown in FIGS. 17A-17B also has a locking device 292 configured to lock the asset 278 in place after the asset is coupled to the asset tracking port 274. The locking device 292 is also configured to unlock the asset 278 so that it can be removed from the tracking communication port 274. As illustrated in this embodiment, the locking device 292 may include a pin 294 that can be extended and retracted, for example with or as part of a solenoid, to secure and release the asset 278. Other types of locking devices will be apparent to those skilled in the art and are to be included within the scope of the appended claims.

Since the translation circuitry 282 is configured to present the at least one unique asset identifier to a controller when the asset is coupled to the tracking communication port, the controller is able to track when a certain asset is present and when it has been removed. With embodiments like those of FIGS. 17A and 7B, where there is also a locking device 292, the controller can release certain assets to authorized users while preventing the removal of other assets. In this way, secondary assets 288 may be even more secure in the storage cavity while the asset 278 is coupled to the asset management device 290.

In other embodiments, the asset 278 may be suitably programmed to implement instructions for a method to display the contents of the storage cavity 280. Using either a light (for example a camera flash) on the back side of the asset or a light source from within or without the housing 284, a camera on the back of the asset storage device could be configured to capture and/or display a picture of the one or more secondary assets stored in the storage cavity 280. Such a picture could then be displayed locally on the screen of the asset 278 and/or viewed remotely.

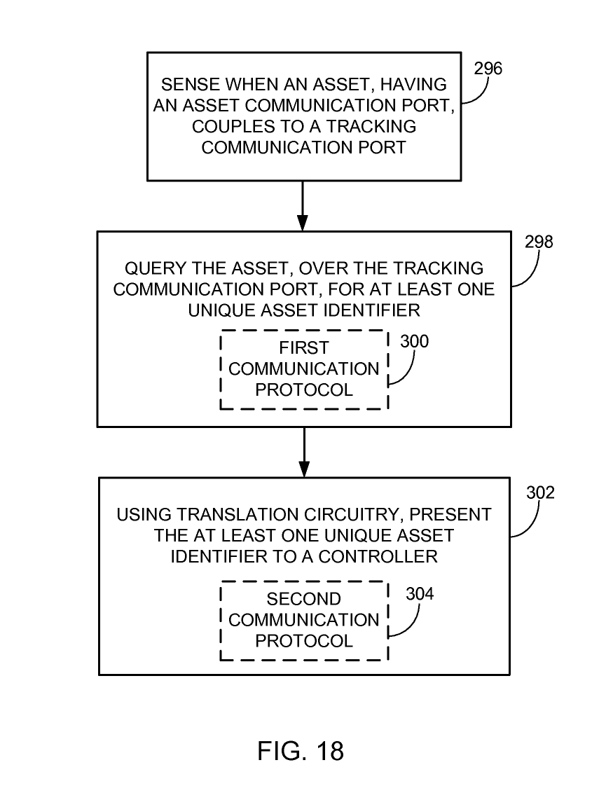

FIG. 18 illustrates one embodiment of a method of asset management. In step 296, an asset having an asset communication port is sensed when it couples to a tracking communication port. This can be accomplished, for example, with translation circuitry coupled to a tracking communication port as discussed above. In step 298, the asset is queried, over the tracking communication port, for at least one unique asset identifier. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can also be accomplished, for example, with translation circuitry coupled to the tracking communication port as discussed above. In some embodiments, this query may occur using a first communication protocol 300. Non limiting examples of a first communication protocol include a radio frequency identification (RFID) protocol, a radio frequency (RF) protocol, a near field communication (NFC) protocol, a Bluetooth protocol, a universal serial bus (USB) protocol, a firewire protocol, a serial communication protocol, a parallel communication protocol, and an optical communication protocol. Examples of unique asset identifiers have also been discussed above, and may include, but are not limited to a media access control (MAC) address, a vendor identification (VID), a product identification (PID), a product serial string, or any combination thereof. In step 302, using translation circuitry, the at least one unique asset identifier is presented to a controller. In some embodiments, this presentation may occur using a second communication protocol 304. Non-limiting examples of a second communication protocol include a 1-Wire communication protocol and a communication bus protocol.

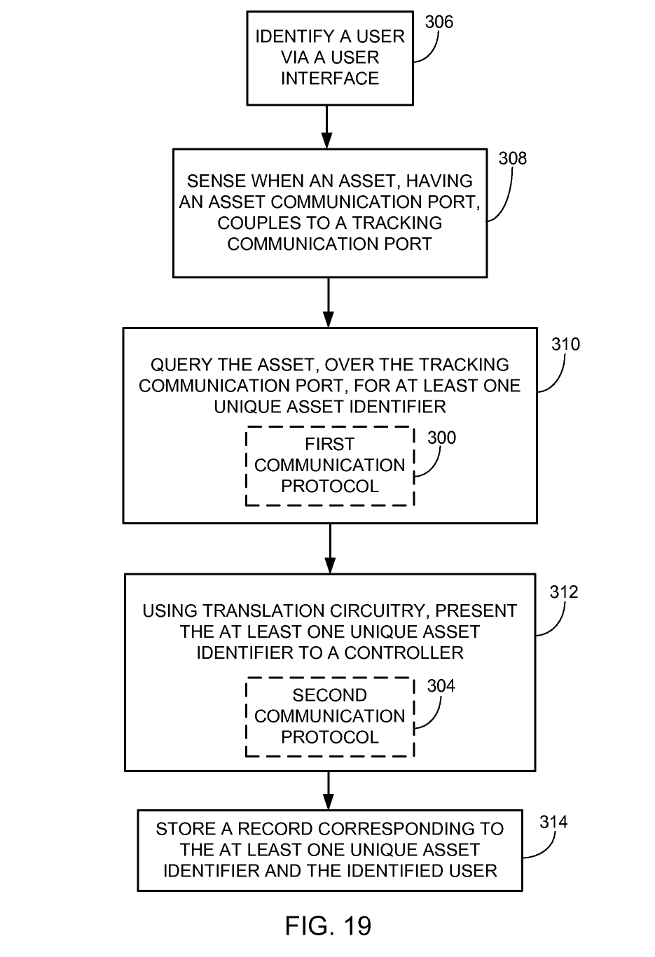

FIG. 19 illustrates another embodiment of a method of asset management. In step 306, a user is identified via a user interface. As discussed previously, examples of a suitable user interface include, but are not limited to a keypad, a fingerprint reader, a proximity card reader, an iris identification device, a retinal scanning identification device, a hand shape identification device, and a magnetic card reader. In step 308, an asset having an asset communication port is sensed when it couples to a tracking communication port. This can be accomplished, for example, with translation circuitry coupled to a tracking communication port as discussed above. In step 310, the asset is queried, over the tracking communication port, for at least one unique asset identifier. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can also be accomplished, for example, with translation circuitry coupled to the tracking communication port as discussed above. In some embodiments, this query may occur using a first communication protocol 300 as discussed previously. In step 312, using translation circuitry, the at least one unique asset identifier is presented to a controller. In some embodiments, this presentation may occur using a second communication protocol 304 as also discussed previously. In step 314, a record is stored corresponding to the at least one unique asset identifier and the identified user. Such a record could be stored in a database or other storage or memory. One example of a record stored could include the name and/or identification of the user identified via the user interface and a list of one or more assets removed and/or returned by the user. Such a record may also include information showing the date/time the transaction took place and/or an alarm or report status for the transaction.

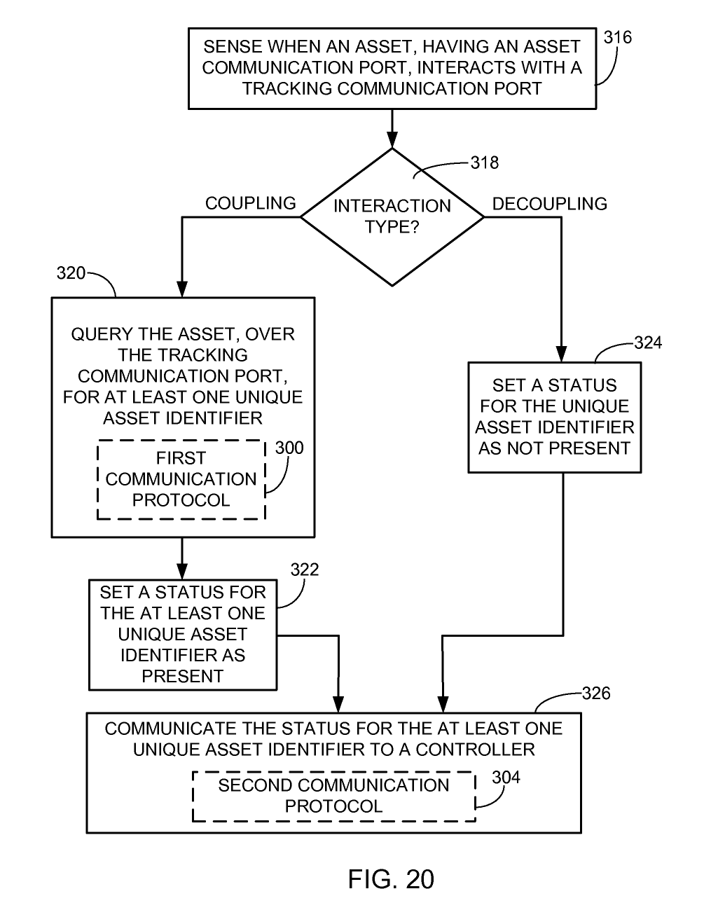

FIG. 20 illustrates a further method of asset management. In step 316, an asset having an asset communication port is sensed when it interacts with a tracking communication port. This can be accomplished, for example, with translation circuitry coupled to a tracking communication port as discussed above. The interaction between the asset communication port and the tracking communication port can be a coupling, for example, when the asset is returned and plugged into the tracking communication port. Alternatively, the interaction between the asset communication port and the tracking communication port can be a decoupling, for example, when the asset is removed and unplugged from the tracking communication port.

A determination 318 is made whether or not the sensed interaction of the asset communication port with the tracking communication port is a coupling or a decoupling. If the interaction comprises a coupling, then in step 320, the asset is queried over the tracking communication port for at least one unique asset identifier. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can also be accomplished, for example, with translation circuitry coupled to the tracking communication port as discussed above. In some embodiments, this query may occur using a first communication protocol 300 as discussed previously. In step 322, a status for the at least one unique asset identifier is set as present. Alternatively, if determination 318 finds that the interaction comprises a decoupling, then in step 324, the status for the at least one unique asset identifier is set as not present. Whether the interaction was a coupling or a decoupling, after the status is set to present or not present, the status for the at least one unique asset identifier is communicated to a controller in step 326. In some embodiments, this communication may occur using a second communication protocol 304 as also discussed previously.

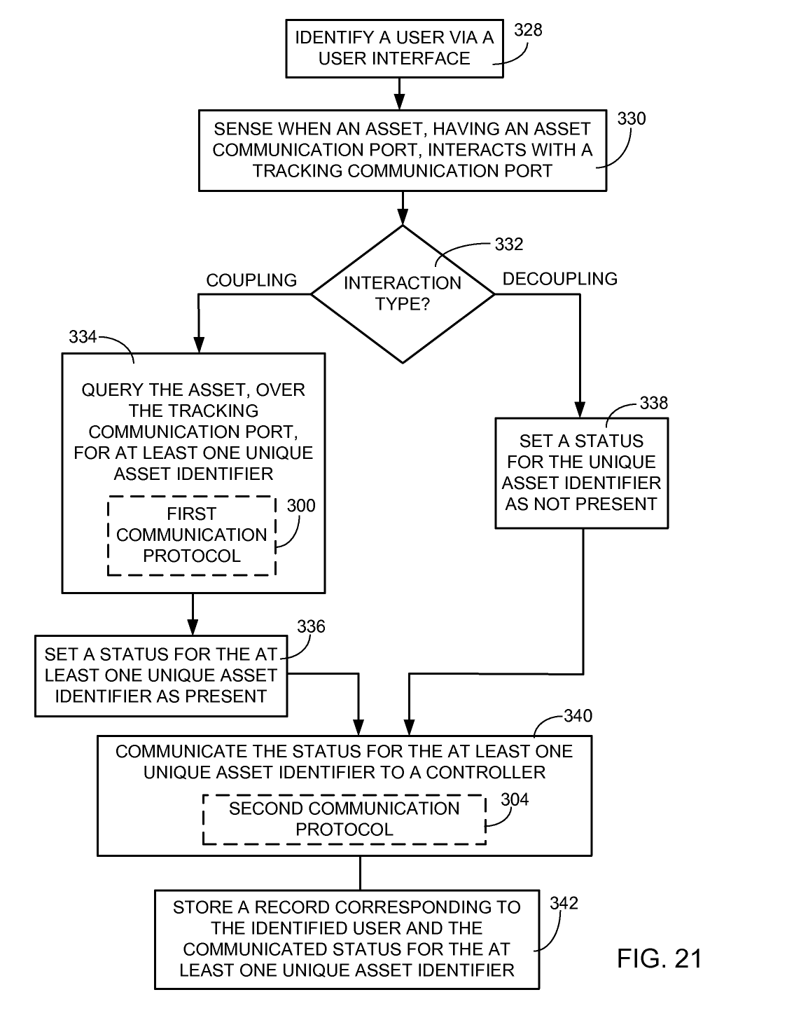

FIG. 21 illustrates another embodiment of a method for asset management. In step 328, a user is identified via a user interface. As discussed previously, examples of a suitable user interface include, but are not limited to a keypad, a fingerprint reader, a proximity card reader, an iris identification device, a retinal scanning identification device, a hand shape identification device, and a magnetic card reader. In step 330, an asset having an asset communication port is sensed when it interacts with a tracking communication port. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can be accomplished, for example, with translation circuitry coupled to a tracking communication port as discussed above. The interaction between the asset communication port and the tracking communication port can be a coupling, for example, when the asset is returned and plugged into the tracking communication port. Alternatively, the interaction between the asset communication port and the tracking communication port can be a decoupling, for example, when the asset is removed and unplugged from the tracking communication port.

A determination 332 is made whether or not the sensed interaction of the asset communication port with the tracking communication port is a coupling or a decoupling. If the interaction comprises a coupling, then in step 334, the asset is queried over the tracking communication port for at least one unique asset identifier. This can also be accomplished, for example, with translation circuitry coupled to the tracking communication port as discussed above. In some embodiments, this query may occur using a first communication protocol 300 as discussed previously. In step 336, a status for the at least one unique asset identifier is set as present. Alternatively, if determination 332 finds that the interaction comprises a decoupling, then in step 338, the status for the at least one unique asset identifier is set as not present. Whether the interaction was a coupling or a decoupling, after the status is set to present or not present, the status for the at least one unique asset identifier is communicated to a controller in step 340. In some embodiments, this communication may occur using a second communication protocol 304 as also discussed previously. In step 342, a record is stored corresponding to the at least one unique asset identifier and the identified user. Such a record could be stored in a database or other storage or memory. One example of a record stored could include the name and/or identification of the user identified via the user interface and a list of one or more assets removed and/or returned by the user. Such a record may also include information showing the date/time the transaction took place and/or an alarm or report status for the transaction.

Having thus described several embodiments of the claimed invention, it will be rather apparent to those skilled in the art that the foregoing detailed disclosure is intended to be presented by way of example only, and is not limiting. Many advantages for the systems and methods for communication port based asset management have been discussed. Various alterations, improvements, and modifications will occur and are intended to those skilled in the art, though not expressly stated herein. These alterations, improvements, and modifications are intended to be suggested hereby, and are within the spirit and the scope of the claimed invention. As one example, it may be desirable to provide a feedback indicator, such as a light emitting diode (LED), near each asset tracking port or easily associated with each asset tracking port so that a controller may enable the feedback indicator following user authentication to show then which asset(s) may be validly removed by the user. In some embodiments, if the asset has a screen or other feedback indicator built into the asset, then the controller might send a command to the asset, over the tracking communication port/asset communication port connection to turn on a feedback indicator on the device (for example, by turning on the display of the device) when it's authorized user has authenticated with the system.

Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A computer program product including instructions in the form of computer executable code on a non-transitory computer readable storage medium, the instructions when executed by a computer processor in communication with the non-transitory computer readable storage medium causing the computer processor to perform a method of asset management comprising:
sensing an interaction of an asset communication port of an asset with one of a universal serial bus (USB) port of a tracking communication port and a radio frequency (RF) port of the tracking communication port;
responsive to the interaction including coupling the asset communication port to the tracking communication port, querying the asset via the tracking communication port for at least one unique asset identifier using a first communication protocol, the first communication protocol including a corresponding one of a USB protocol and an RF protocol;
converting the at least one unique identifier into a respective converted asset identifier compatible with a second communication protocol that differs from the first communication protocol; and
presenting the converted asset identifier to a controller using the second communication protocol.

2. The computer program product of claim 1, wherein the RF port comprises a radio frequency identification (RFID) port.

3. The computer program product of claim 1, wherein the RF port comprises a near field communication (NFC) port.

4. The computer program product of claim 1, wherein the at least one unique asset identifier includes a media access control (MAC) address.

5. The computer program product of claim 1, wherein the at least one unique asset identifier includes at least one of a vendor identification (VID), a product identification (PID), and a product serial string.

6. The computer program product of claim 1, wherein the second communication protocol includes the Dallas Semiconductor/Maxim Integrated 1-Wire protocol and converting the at least one unique asset identifier to a converted asset identifier includes packaging the at least one unique asset identifier within one or more bytes formatted to comply with the Dallas Semiconductor/Maxim Integrated 1-Wire protocol.

7. The computer program product of claim 1, wherein the method further comprises identifying a user via a user interface and storing a record corresponding to the converted unique asset identifier and the user.

8. The computer program product of claim 1, wherein the method further comprises:
responsive to the interaction including a coupling of the asset communication port to the tracking communication port, setting a status for the at least one unique asset identifier as present;
responsive to the interaction including a decoupling of the asset communication port from the tracking communication port, setting the status for the at least one unique asset identifier as not present; and
including the status for the at least one unique asset identifier in the converted asset identifier.

9. A system for asset management, comprising:
a communication bus other than a universal serial bus (USB);
a tracking communication port including a USB port arranged to selectively couple with a corresponding asset communication port;
a USB host device coupled to the USB port of the tracking communication port and that queries an asset for a USB profile responsive to the respective asset communication port coupling with the USB port of the tracking communication port, the USB profile including at least one of a media access control (MAC) address, a vendor identification (VID), a product identification (PID), and a serial number;
translation circuitry coupled to the USB host device and the communication bus, the translation circuitry receiving at least a portion of the USB profile from the USB host device, converts the at least a portion of the USB profile to a respective unique asset identifier compatible with the communication bus, and sends the respective unique asset identifier to the communication bus;
a database configurable to store at least one asset record on a non-transitory computer readable storage medium;
a user interface (UI); and
a controller coupled to the communication bus, the database, and the UI, the controller identifying a user via the UI, receiving the respective unique asset identifier via the communication bus, and storing an asset record corresponding to the respective unique asset identifier in the database.

10. The system of claim 9, wherein the USB profile comprises a product serial string, a VID, and a PID.

11. The system of claim 9, wherein the communication bus is a Dallas Semiconductor/Maxim Integrated 1-Wire bus and the translation circuitry communicates via the Dallas Semiconductor/Maxim Integrated 1-Wire protocol.

12. The system of claim 11, wherein the translation circuitry converts the at least a portion of the USB profile to a respective unique asset identifier compatible with the communication bus by packaging the at least one unique asset identifier within one or more bytes formatted to comply with the 1-Wire protocol

13. The system of claim 9, further comprising a microprocessor that includes the USB host device and the translation circuitry.

14. The system of claim 13, wherein the microprocessor includes a peripheral interface controller (PIC).

15. The system of claim 1, further comprising a second tracking communication port including a radio frequency identification (RFID) reader coupled to the translation circuitry and the translation circuitry includes circuitry that receives a RFID code from a corresponding asset communication port, converts the RFID code to a respective unique asset identifier compatible with the communication bus, and sends the respective unique asset identifier to the communication bus.

16. The system of claim 15, wherein the RFID reader includes an RFID front end, an RFID clock coupled to the RFID front end, tuning circuitry coupled to the RFID front end, an antenna driver coupled to the tuning circuitry, and an antenna coupled to the antenna driver.

17. An asset tracking device, comprising:
a tracking communication port including a USB port arranged to selectively couple with a corresponding asset communication port;
a USB host device coupled to the USB port of the tracking communication port and that queries an asset for a USB profile responsive to the respective asset communication port coupling with the USB port of the tracking communication port, the USB profile including at least one of a media access control (MAC) address, a vendor identification (VID), a product identification (PID), and a serial number;
translation circuitry coupled to the USB host device and the communication bus, the translation circuitry receiving at least a portion of the USB profile from the USB host device, converts the at least a portion of the USB profile to a respective unique asset identifier compatible with a communication bus, and sends the respective unique asset identifier to a controller.

18. The asset tracking device of claim 17, wherein the translation circuitry is coupled to a 1-wire bus using a Dallas Semiconductor/Maxim Integrated 1-Wire Protocol and presents the respective unique asset identifier to the controller by packaging the respective unique asset identifier within at least one byte formatted to comply with the Dallas Semiconductor/Maxim Integrated 1-Wire Protocol and transmitting the at least one byte to the 1-Wire bus.

19. The asset tracking device of claim 17, further comprising power circuitry selectively coupled to and receiving power from at least one external power connection, the external power connection including a universal serial bus (USB) power connector and at least one voltage supply pin.

20. The asset tracking device of claim 17, further comprising a housing at least partially enclosing the tracking communication port and the translation circuitry.
